(19) United States
(12) Patent Application Publication
(10) Pub. No.: US 2026/0219367 A1
(43) Pub. Date: Jul. 30, 2026

(54) FOCAL PLANE ARRAY SYSTEM AND LIDAR DEVICE INCLUDING THE SAME

(71) Applicant: SAMSUNG ELECTRONICS CO., LTD., Suwon-si (KR)

(72) Inventors: Sunil KIM, Suwon-si (KR); Minkyung LEE, Suwon-si (KR)

(73) Assignee: SAMSUNG ELECTRONICS CO., LTD., Suwon-si (KR)

(21) Appl. No.: 19/232,105

(22) Filed: Jun. 9, 2025

(30) Foreign Application Priority Data
Jan. 24, 2025 (KR) 10-2025-0011692

(51) Int. Cl. G01S 7/481; G02B 6/42

(52) U.S. Cl. CPC G01S 7/4816; G02B 6/4214

(57) ABSTRACT

An optical sensor may include an input coupler configured to couple a light beam, a plurality of pixels on a substrate, a waveguide configured to transmit the light beam to the plurality of pixels. Each of the plurality of pixels may include an optical switch configured to selectively transmit the light beam; an output coupler comprising an inclined side surface and configured to change a traveling direction of the light beam to output the light beam in the changed traveling direction, and a nano-structure element on a traveling path of the light beam output from the output coupler and comprising at least one nano structure.

### CROSS-REFERENCE TO RELATED APPLICATION

This application is based on and claims priority under 35 U.S.C. §119 to Korean Patent Application No. 10-2025-0011692, filed on January 24, 2025, in the Korean Intellectual Property Office, the disclosure of which is incorporated by reference herein in its entirety.

### BACKGROUND

### 1.Field

One or more embodiments of the present disclosure relate to a focal plane array system and a light detection and ranging (LiDAR) device including the same.

### 2.Description of the Related Art

Light detection and ranging (LiDAR) devices have been used in various fields such as autonomous driving devices including unmanned cars, autonomous driving vehicles, drones, robots, etc., precision measurement devices, and so forth.

A LiDAR driving method may be roughly divided into a pulse driving scheme and a continuous wave driving scheme which has advantages of low peak output, high safety, high light efficiency, etc. In particular, among them, a frequency-modulated continuous wave (FMCW) driving scheme is capable of identifying, in real time, 4-dimensional (4D) information including distance information and speed information for an object through modulation to linearly increase or decrease the frequency of output light, and is robust against noise.

The FMCW driving scheme has high distance resolution and speed resolution even in an environment with ambient noise, and in particular, is capable of using a light source of low peak power, thus being appropriate for implementing silicon photonics-based LiDAR having difficulty in securing a high light output.

For a LiDAR system, a technique for scanning a LiDAR front space (an x-y plane) at a high resolution to identify objects is required as well as a technique for measuring the distance to an object and the speed of the object with high precision. The scanning technique roughly includes a flash scheme, a mirror scanning scheme, an optical phased array (OPA) scheme, a dispersive scheme, a focal plane array (FPA) scheme, etc., and the front space is scanned applying such scanning schemes alone or in combination to an x-y axis. Among them, the FPA scheme is appropriate for the FMCW driving scheme because of having a lower control technique complexity and a more excellent side mode suppression ratio (SMSR) feature than other schemes.

A beam scanning scheme using silicon photonics includes a scheme using an OPA and a scheme using an FPA, and the scheme using the FPA is appropriate for the FMCW driving scheme because of having a low complexity and a superior SMSR.

### SUMMARY

One or more embodiments provide a focal plane array (FPA), which is appropriate for implementing silicon photonics-based light detection and ranging (LiDAR) and minimizes light loss, and a LiDAR device including the FPA.

According to an aspect of the disclosure, an optical sensor may include: an input coupler configured to couple a light beam; a plurality of pixels on a substrate; and a waveguide configured to transmit the light beam to the plurality of pixels. Each of the plurality of pixels may include: an optical switch configured to selectively transmit the light beam; an output coupler comprising an inclined side surface and configured to change a traveling direction of the light beam to output the light beam in the changed traveling direction; and a nano-structure element on a traveling path of the light beam output from the output coupler and comprising at least one nano structure.

According to an aspect of the disclosure, a light detection and ranging (LiDAR) device may include: a processor configured to control the LiDAR device; an input coupler configured to couple a light beam incident on the LiDAR device; a plurality of pixels configured to receive the light beam reflected from an object; a waveguide configured to transmit the light beam from the input coupler to the plurality of pixels. The plurality of pixels may be provided on a substrate and may include: an optical switch configured to selectively transmit the light beam; an output coupler comprising an inclined side surface and configured to change a traveling direction of the light beam to output the light beam in the changed traveling direction; and a nano-structure element provided on a traveling path of the light beam output from the output coupler and comprising at least one nano structure.

According to an aspect of the disclosure, an optical sensor may include a plurality of pixels on a substrate, each of the plurality of pixels including: an input coupler configured to couple incident light; an output coupler comprising an inclined side surface; a waveguide extending from the input coupler to the output coupler; and a nanostructure positioned at a level different from a level of the output coupler relative to the substrate. The inclined side surface of the output coupler may be configured to redirect the light toward the nanostructure at the different level.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically shows a focal plane array (FPA) system according to one or more embodiments;

FIG. 2 shows a light-output structure of the FPA system of FIG. 1 according to one or more embodiments;

FIG. 3 shows a light-output structure of the FPA system of FIG. 1 according to one or more embodiments;

FIG. 4 shows a light-output structure of the FPA system of FIG. 1 according to one or more embodiments;

FIGS. 5 to 9 show a method of manufacturing a light-output structure of the FPA of FIG. 2;

FIGS. 10 to 16 show a method of manufacturing a light-output structure of the FPA of FIG. 4;

FIG. 17 is a block diagram for describing a processor of a LiDAR device according to one or more embodiments;

FIG. 18 schematically shows a LiDAR device according to one or more embodiments;

FIG. 19 is a block diagram showing a schematic configuration of an electronic device including a LiDAR device according to one or more embodiments; and

FIG. 20 schematically shows an example in which a LiDAR device according to one or more embodiments is applied to a vehicle.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects. As used herein, the term "and/or" includes any and all combinations of one or more of the associated listed items. Expressions such as "at least one of," when preceding a list of elements, modify the entire list of elements and do not modify the individual elements of the list.

Hereinafter, various embodiments disclosed herein will be described in detail with reference to the accompanying drawings. In the drawings, like reference numerals denote like components, and sizes of components in the drawings may be exaggerated for convenience of explanation. Meanwhile, embodiments to be described are merely examples, and various modifications may be made from such embodiments.

When an expression "above" or "on" may include not only "directly on/under/at left/right contactually", but also "on/under/at left/right contactlessly". Singular forms may include plural forms unless apparently indicated otherwise contextually. In case that a portion is referred to as "comprises" a component, the portion may not exclude another component but may further include another component unless stated otherwise.

The use of the terms of "the above-described" and similar indicative terms may correspond to both the singular forms and the plural forms. When there is an explicit description of the order of operations of the method or there is no description contrary thereto, these operations may be performed in an appropriate order and the order is not necessarily limited to the described order.

The term used herein such as "unit" or "module" indicates a unit for processing at least one function or operation, and may be implemented in hardware, software, or in a combination of hardware and software.

Connections of lines or connection members between components shown in the drawings are illustrative of functional connections and/or physical or circuit connections, and in practice, may be represented as alternative or additional various functional connections, physical connections, or circuit connections.

The use of all examples or terms is only to describe technical spirit in detail, and the scope is not limited by these examples or terms unless limited by the claims.

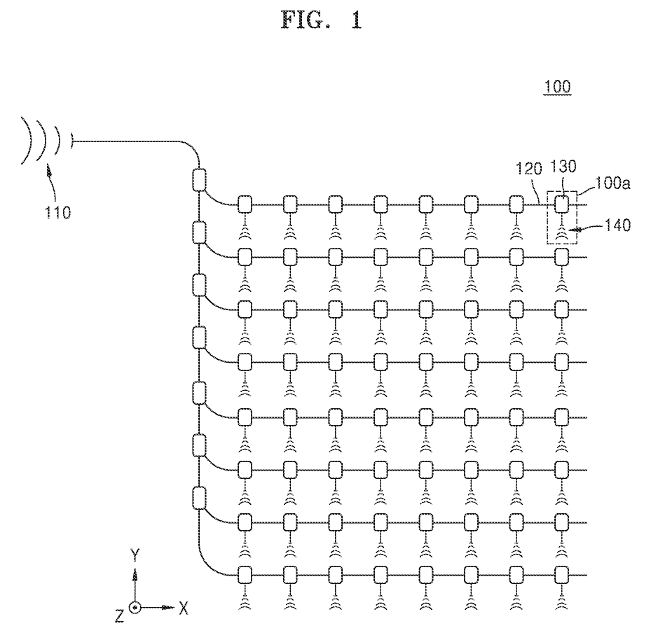

FIG. 1 schematically shows a focal plane array (FPA) system 100 according to one or more embodiments. The FPA system 100 is an example of an optical sensor, which detects and processes light to generate an image or other optical data.

Referring to FIG. 1, the FPA system 100 may include an input coupler 110, a waveguide 120, and a plurality of pixels 100a. The plurality of pixels 100a may be arranged in a grid, where each pixel operates as an individual light detector, responding to incoming light and converting it into an electrical signal. Each of the plurality of pixels 100a may include the waveguide 120, an optical switch 130, and an output coupler 140. The plurality of pixels 100a may be two-dimensionally arranged on a substrate. For example, the plurality of pixels 100a may be arranged on the substrate in a first direction (an X direction) and a second direction (a Y direction). A light detection and ranging (LiDAR) device may include the FPA system 100 and selectively activate the plurality of pixels 100a of the FPA system 100 to 1-dimensionally or 2-dimensionally scan one or more light beams.

The substrate may be a photonic integrated circuit (PIC) substrate, e.g., a silicon PIC substrate. On the substrate, a circuit for driving a light source, a light-receiving circuit for detecting an interference signal received in a photodetector, etc., may be integrated.

The input coupler 110 may couple the light beam emitted from the light source to direct the light beam to the waveguide 120. The light source may be a multi-wavelength light source. The light beam emitted from the light source may be guided and provided to each pixel 100a of the FPA system 100 through the waveguide 120 by the input coupler 110. A coupling strength of the input coupler 110 may be adjusted based on, for example, the depth of a lattice, the refractive index difference with surrounding materials. For coupling strength adjustment, an optical material such as silicon dioxide (SiO₂), etc., may be further deposited on the input coupler 110.

The waveguide 120 may transmit the coupled light beam to each pixel 100a. The waveguide 120 may transmit the light beam coupled by the input coupler 110 to the optical switch 130 of each pixel 100a. The waveguide 120 may optically connect the input coupler 110 to the optical switch 130. The waveguide 120 may include optical materials of high refractive index, such as silicon (Si), silicon nitride (SiN), titanium dioxide (TiO₂), etc. The waveguide 120 may be formed, for example, by depositing and etching the optical materials of high refractive index, such as Si, SiN, TiO₂, etc., on the substrate.

A plurality of optical switches 130 may be selectively controlled to transmit the light beam transmitted from the waveguide 120. Each of the plurality of optical switches 130 may selectively transmit the light beam to the output coupler 140. The optical switch 130 may transmit or block the light beam. The optical switch 130 may operate based on thermal or electrical actuation, wherein the optical switch 130 is driven by heat or electric current, allowing for switching between an on state and an off state.

The output coupler 140 may change a traveling direction of the light beam received through the optical switch 130. The output coupler 140 may change or deflect the traveling direction of the light beam in a third direction (a Z direction). The output coupler 140 may change or deflect the traveling direction of the light beam toward the nano-structure element 141, and output the light beam in the changed direction. The output coupler 140 may have an inclined cross-section (e.g., an inclined side surface or an inclined edge) relative to a surface of the substrate. The output coupler 140 may be a side edge coupler (SEC).

The light beams reflected from an object may interfere with a local oscillator (LO) light beam and then may be measured by a balanced photodiode (BPD). The LiDAR device including the FPA system 100 according to one or more embodiments may calculate the distance and speed of the object by measuring a pulsation frequency of the interference signal.

The LiDAR device including the FPA system 100 according to one or more embodiments may transmit a signal light beam of a frequency-modulated continuous wave (FMCW), such that the LiDAR device including the FPA system 100 according to one or more embodiments may be implemented as an FMCW LiDAR device.

Hereinbelow, a light-output structure applicable to each pixel of an FPA system will be described.

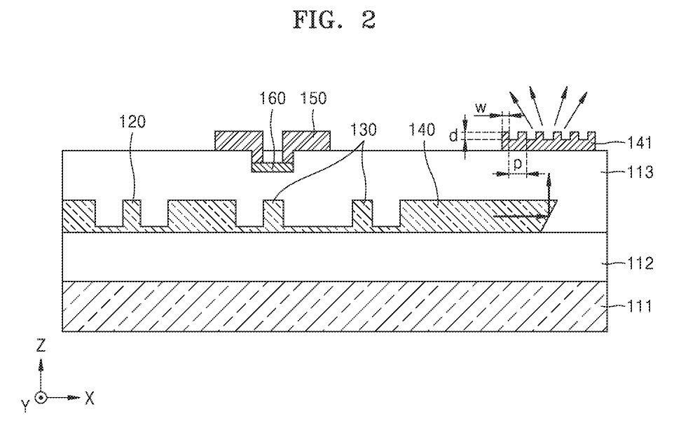

FIG. 2 shows a light-output structure of the FPA system 100 of FIG. 1 according to one or more embodiments.

Referring to FIG. 2, the light-output structure of the FPA system may include the waveguide 120, the optical switch 130, the output coupler 140, and the nano-structure element 141.

A buried oxide (BOX) layer 112 may be provided on a substrate 111, and the waveguide 120, the optical switch 130, and the output coupler 140 may be provided on the BOX layer 112. The substrate 111 may include silicon (Si). An upper Si layer on which the substrate 111, the BOX layer 112, and the waveguide 130 are formed may form a silicon-on-insulator (SOI) wafer.

The waveguide 120, the optical switch 130, and the output coupler 140 may be provided at the same level in the third direction (the Z direction). The waveguide 120, the optical switch 130, and the output coupler 140 may have the same spacing distance from a surface of the substrate 111 in the third direction (the Z direction). For example, a spacing distance between the output coupler 140 and the substrate 111 may be the same as a spacing distance between the waveguide 120 and the substrate 111. A cladding layer 113 may be provided on the waveguide 120, the optical switch 130, and the output coupler 140. The nano-structure element 141 may be provided on the cladding layer 113. The nano-structure element 141 may be provided spaced apart from the output coupler 140 in the third direction (the Z direction).

The output coupler 140 may have an inclined cross-section (e.g., an inclined side surface or an inclined edge) relative to the substrate 111. The output coupler 140 may be an SEC, and its inclined geometry redirects the incident light beam. The traveling direction of the light beam incident to the output coupler 140 may be changed due to the inclined cross-section of the output coupler 140 such that the light beam may be output to the nano-structure element 141. An output angle of the light beam may be adjusted by an angle of the inclined cross-section of the output coupler 140. The output coupler 140 may have a high light-output efficiency by including the inclined cross-section. The output coupler 140 having the inclined cross-section may have a high light-output efficiency of, for example, 80 % to 90 % or higher. The output coupler 140 having the inclined cross-section may output the light beam toward the nano-structure element 141 at the same angle and efficiency for most wavelengths without wavelength dependency with respect to the center wavelength.

The nano-structure element 141 may be provided on a traveling path of the light beam output from the output coupler 140. The nano-structure element 141 may be provided on the output coupler 140 in the third direction (the Z direction). The nano-structure element 141 may include at least one nano-structure. Each nano-structure may have a size (e.g., a pitch p or a width w) not more than an operating wavelength of the FPA system. Each nano-structure may have a size less than a wavelength of incident light. A light-output angle of the light beam incident to the nano-structure element 141 may change according to the wavelength of the incident light due to the nano-structure element 141. The light-output angle of the light beam may be adjusted by the size of the nano-structure element 141.

At least one nano-structure of the nano-structure element 141 may be, for example, a lattice structure (e.g., a grating structure including grooves and ridges). The lattice structure of the nano-structure element 141 may extend in the second direction (the Y direction), and a plurality of lattice structures (e.g., ridges that protrude from a bottom surface of the grating structure) may be provided spaced apart from each other in the first direction (the X direction). A pitch p (e.g., the distance between lattice structures in the first direction (the X direction)) of each of the plurality of lattice structures of the nano-structure element 141 may be at least 50 nm, but not more than 500 nm. A depth d of each of the plurality of lattice structures (e.g., a length in the third direction (the Z direction) from a top surface to a bottom surface of the lattice structure) may be at least 100 nm, but not more than 350 nm. A duty ratio of the lattice structure of the nano-structure element 141 (e.g., a percentage of a width w of the lattice structure with respect to the pitch p of the lattice structure) may be at least 10 %, but not more than 50 %.

The nano-structure element 141 may have a high light-output efficiency by including a material having small light loss at an incident wavelength. The nano-structure element 141 may include a high refractive-index material with a high transmissivity. The nano-structure element 141 may include, for example, Si₃N₄, Si, TiO₂, SiO₂, or a combination thereof.

The light-output structure of the FPA system may include the output coupler 140 having the inclined cross-section and the nano-structure element 141 in a light-output region of the light beam, thereby radiating light to various positions according to the wavelength of the incident light in a single light-output area, providing a high light-output efficiency, increasing the number of measurement points, and thus improving the resolution of the LiDAR device.

The light-output structure of the FPA system may further include an electrode 150 and a heater 160. The electrode 150 may provide an electrical signal required to drive the optical switch 130. The heater 160 may include, for example, tungsten (W), titanium nitride (TiN), gold (Au), silicon (Si), or a combination thereof. The heater 160 may modulate properties of the optical switch through thermal effects, to control on/off states of the optical switch 130.

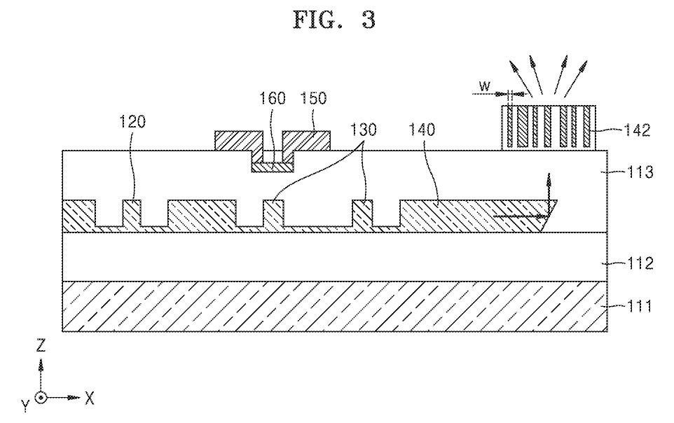

FIG. 3 shows a light-output structure of the FPA system 100 of FIG. 1 according to one or more embodiments. Referring to FIG. 2, a description will be made mainly of the differences and like reference numerals refer to like components.

Referring to FIG. 3, a nano-structure element 142 may include at least one nano-structure. A light-output angle of the light beam incident to the nano-structure element 141 may change according to the wavelength of the incident light due to the nano-structure element 142.

The nano structure may be a nano-rod, having, for example, a cylindrical shape or a polyprismatic shape. A cross-section of the nano structure may have various shapes such as a circle, a triangle, a quadrangle, etc. The width w of each nano structure may be at least 50 nm, but not more than 500 nm. The nano-structure element 142 may include a cladding layer provided on at least one nano-structure.

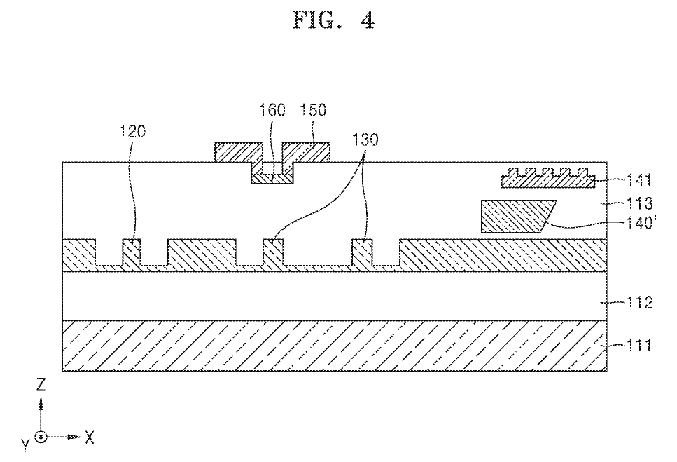

FIG. 4 shows a light-output structure of the FPA system 100 of FIG. 1 according to one or more embodiments. Referring to FIG. 2, a description will be made mainly of the differences and like reference numerals refer to like components.

Referring to FIG. 4, as compared to FIG. 2, an output coupler 140' may not be provided at the same level as the waveguide 120 and the optical switch 130 in the third direction (the Z direction). The output coupler 140' may have different spacing distances with the waveguide 120 and the optical switch 130 relative to a surface of the substrate 111 in the third direction (the Z direction). The output coupler 140' may be provided at a higher level than the waveguide 120 and the optical switch 130 in the third direction (the Z direction). For example, a spacing distance between the output coupler 140' and the substrate 111 may be greater than the spacing distance between the waveguide 120 and the substrate 111. The nano-structure element 141 may be provided buried in the cladding layer 113.

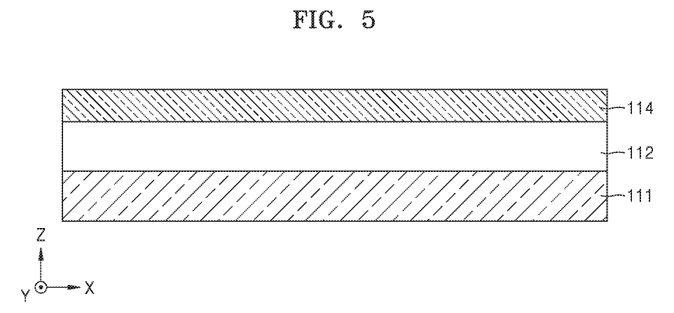

FIGS. 5 to 9 show a method of manufacturing a light-output structure of the FPA of FIG. 2.

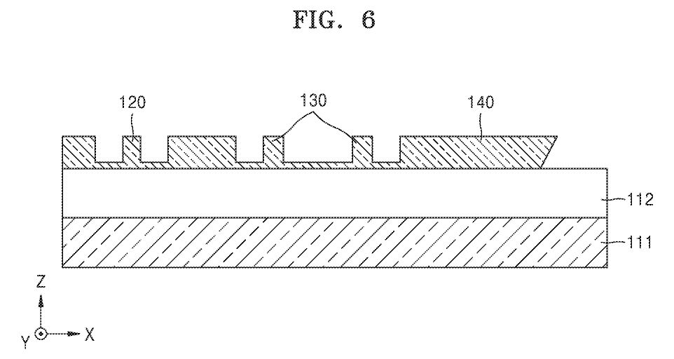

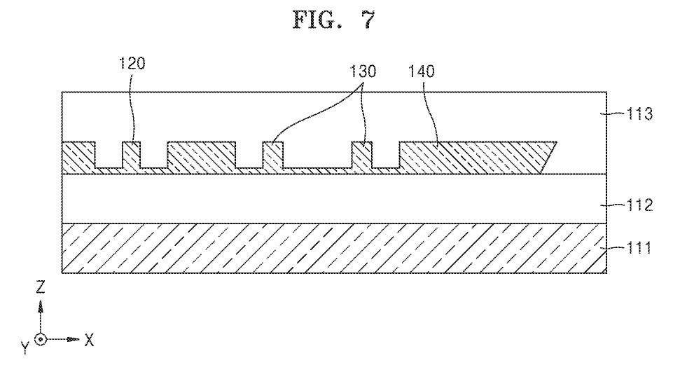

Referring to FIG. 5, an SOI wafer may be formed by sequentially stacking the BOX layer 112 and an upper Si layer 114 on the substrate 111. Referring to FIG. 6, after the SOI wafer is formed, the waveguide 120, the optical switch 130, and the output coupler 140 may be formed on the upper Si layer 114. Referring to FIG. 7, after the waveguide 120, the optical switch 130, and the output coupler 140 are formed on the upper Si layer 114, the cladding layer 113 may be formed on the upper Si layer 114. The cladding layer 113 may include SiO₂.

The output coupler 140 may be formed by etching the upper Si layer 114 through wet etching, e.g., wet etching using a tetramethyl ammonium hydroxide (TMAH) etching solution. By etching silicon according to a crystal orientation of silicon using the TMAH etching solution, a silicon etching surface may be etched in an inclined direction with respect to the substrate 111 due to the crystal orientation.

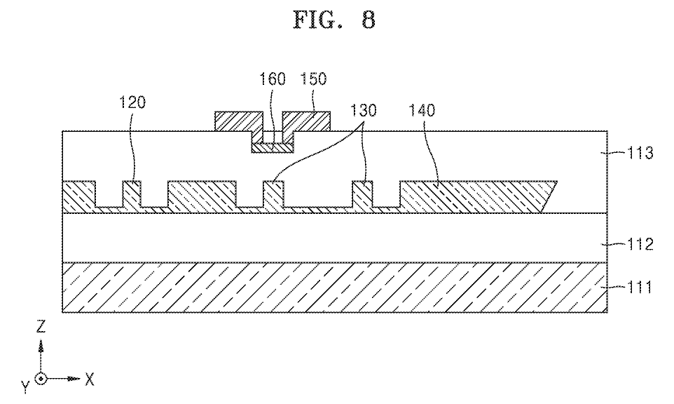

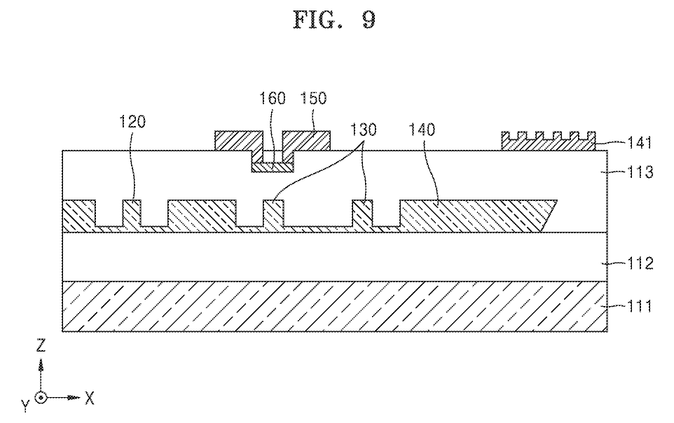

Next, referring to FIG. 8, the electrode 150 and the heater 160 for driving the optical switch 130 may be formed spaced apart from the optical switch 130 on the cladding layer 113 in the third direction (the Z direction). Referring to FIG. 9, the nano-structure element 141 including at least one nano structure may be formed spaced apart from the output coupler 140 on the cladding layer 113 in the third direction (the Z direction). While it is shown in FIG. 9 that the nano-structure element 141 is the nano-structure element 141 having a lattice structure (e.g., a grating structure) for convenience, the nano-structure element 141 may be the nano-structure element 142 of FIG. 3 having a cylindrical shape or a polyprismatic shape.

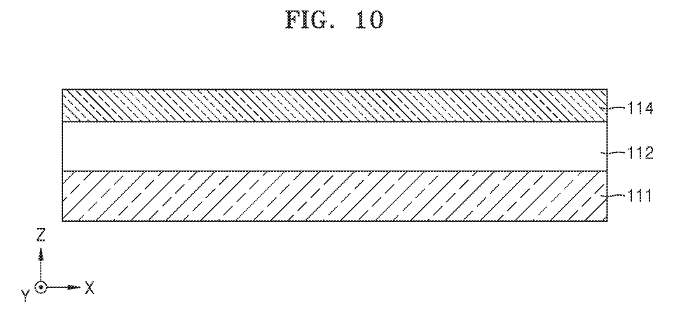

FIGS. 10 to 16 show a method of manufacturing a light-output structure of the FPA of FIG. 4.

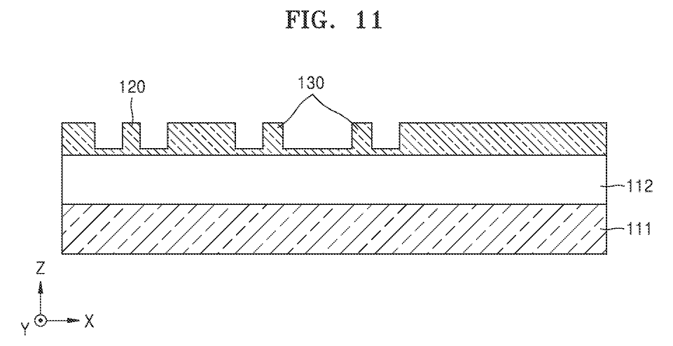

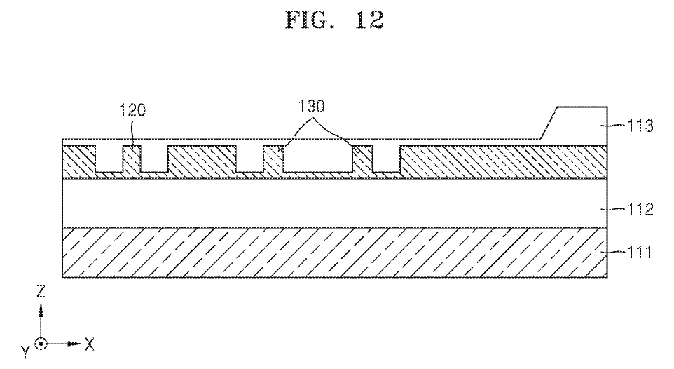

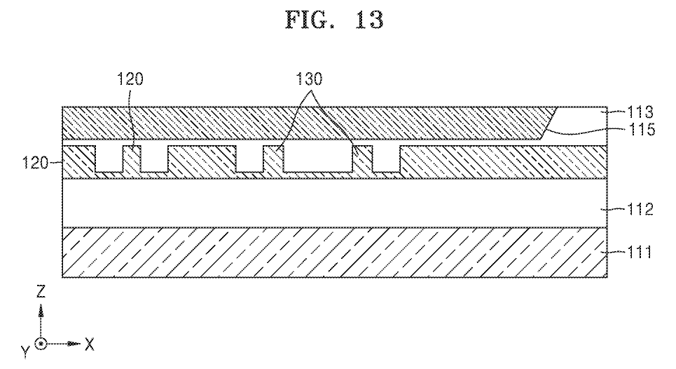

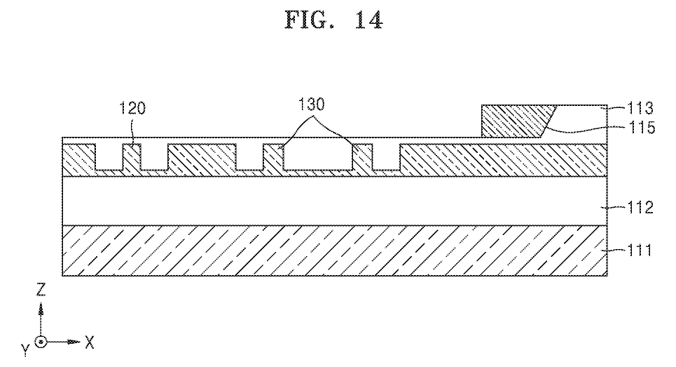

Referring to FIG. 10, an SOI wafer may be formed by sequentially stacking the BOX layer 112 and an upper Si layer 114 on the substrate 111. Referring to FIG. 11, after the SOI wafer is formed, the waveguide 120 and the optical switch 130 may be formed on the upper Si layer 114. Referring to FIG. 12, after the waveguide 120 and the optical switch 130 are formed on the upper Si layer 114, the cladding layer 113 may be deposited on the upper Si layer 114 and an inclined pattern may be formed in a light-output area. Referring to FIG. 13, after the inclined pattern is formed on the cladding layer 113, silicon nitride (Si₃N₄) or amorphous silicon (a-Si) 115 may be deposited on the inclined pattern. Referring to FIG. 14, by planarizing Si₃N₄ or a-Si 115, a waveguide in which the light beam traveling along the waveguide 120 of the lower Si layer 114 are coupled may be formed, and the output coupler 140' for outputting the light beams may be formed. The output coupler 140' may be provided at a higher level in the third direction (the Z direction) than the upper Si layer 114 in which the waveguide 120 and the optical switch 130 are formed.

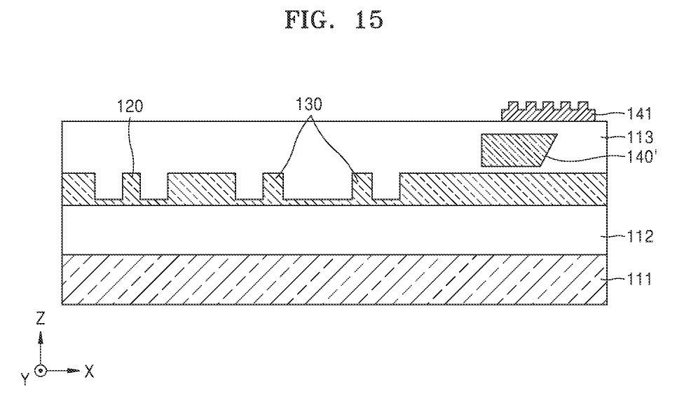

Referring to FIG. 15, the nano-structure element 141 including at least one nano structure may be formed spaced apart from the output coupler 140' on the cladding layer 113 in the third direction (the Z direction). While it is shown in FIG. 14 that the nano-structure element 141 has a lattice structure for convenience, the nano-structure element 141 may have a cylindrical shape or a polyprismatic shape.

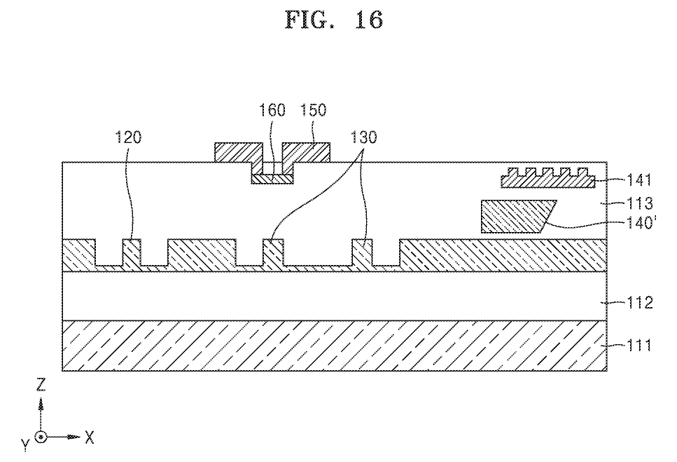

Next, referring to FIG. 16, the electrode 150 and the heater 160 for driving the optical switch 130 may be formed spaced apart from the optical switch 130 on the cladding layer 113 in the third direction (the Z direction).

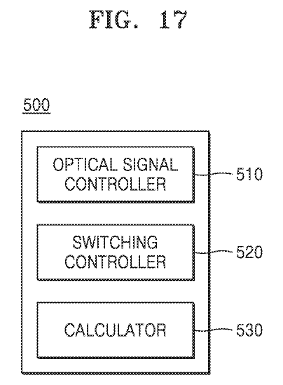

Referring to FIG. 17, a processor 500 may include an optical signal controller 510, a switching controller 520, and a calculator 530.

The processor 500 may perform calculation for obtaining information about an object in a field of view of the LiDAR device. Each of the plurality of pixels 100a of the FPA system 100 may transmit a signal light beam and receive a signal light beam reflected from an object. The processor 500 may perform calculation for obtaining information about the object and handle processing and control of the entire LiDAR device. The processor 500 may obtain and process the information about the object. For example, the processor 500 may obtain and process 2D or 3D image information. The processor 500 may control the overall driving of a transmitter of the FPA system 100, an operation of a receiver of the FPA system 100, etc., For example, the processor 500 may control an electrical signal applied to the transmitter of the FPA system 100. The processor 500 may interpret the distance between the object and the LiDAR device, speeds thereof, the shape of the object, etc., through numeric information provided by the receiver of the FPA system 100. A 3D image obtained by the processor 500 may be transmitted to another unit for use. For example, such information may be transmitted to a processor of an autonomous driving device such as a vehicle, a drone, etc., using the LiDAR device. In addition, such information may be utilized by smartphones, cellular phones, personal digital assistants (PDAs), laptops, personal computers (PCs), wearable devices, and other mobile or non-mobile computing devices. The LiDAR device according to one or more embodiments may include the FPA system 100 according to various embodiments described with reference to FIGS. 1 to 16. The LiDAR device according to one or more embodiments may be applied to smartphones, cellular phones, PDAs, laptops, PCs, wearable devices, etc. For example, a smartphone may extract depth information of subjects in an image through an object 3D sensor by using the LiDAR device according to one or more embodiments or automatically identify the subjects in the image. The LiDAR device according to one or more embodiments may also be applied to a vehicle. The vehicle may include a plurality of LiDAR devices arranged at various positions. The vehicle may provide various information about the inside or periphery of the vehicle to a driver by using the LiDAR device, automatically recognize things or persons in the image, and provide information required for autonomous driving.

The optical signal controller 510 may control frequency modulation (or chirping) of the transmitter and may include a feedback circuit such as a phase-locked loop (PLL). The switching controller 520 may control switching of a structure of the pixel 100a of the FPA system 100. The calculator 530 may calculate at least any one of the distance and the speed of an object based on a bit signal generated by an interference phenomenon between a transmission signal and a received signal. In particular, the calculator 530 may calculate at least any one of the distance and the speed of the object based on the bit signal.

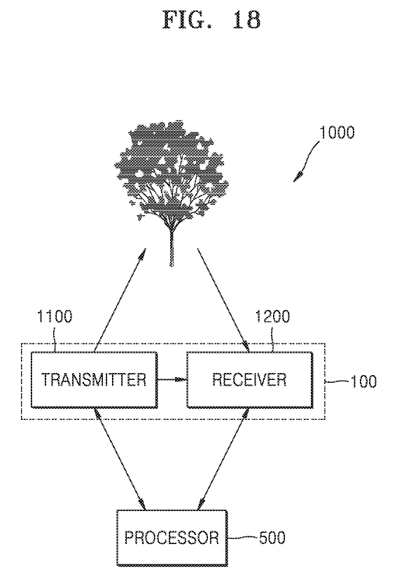

FIG. 18 schematically shows a LiDAR device 1000 according to one or more embodiments.

As shown in FIG. 18, the LiDAR device 1000 may include the FPA system 100 including a transmitter 1100 that radiates light to an object and a receiver 1200 that receives light reflected from the object, and the processor 500 that performs calculation for obtaining information about the object from the light received by the receiver 1200.

The LiDAR device 1000 may selectively activate the plurality of pixels 100a of the FPA system 100 to primarily or secondarily scan one or more light beams, and the processor 500 may perform calculation for obtaining the information about the object. Each of the plurality of pixels 100a of the FPA system 100 may transmit a signal light beam, split a part of the signal light beam into an interference light beam, receive the signal light beam reflected from the object and the interference light beam, and generate an interference signal.

The FPA system 100 and the processor 500 may be implemented as separate devices and as a single device.

The processor 500 may perform calculation for obtaining the information about the object from the light received from the receiver 1200. The processor 500 may handle processing and control of the entire LiDAR device 1000. The processor 500 may obtain and process the information about the object. For example, the processor 500 may obtain and process 2D or 3D image information. The processor 500 may control the overall driving of the transmitter 1100 of the FPA system 100, an operation of the receiver 1200 of the FPA system 100, etc. The processor 500 may also interpret the distance between the object and the LiDAR device 1000, the shape of the object, etc., through the numeric information provided by the receiver 1200.

A 3D image obtained by the processor 500 may be transmitted to another unit for use. For example, such information may be transmitted to the processor 500 of an autonomous driving device such as a vehicle, a drone, etc., using the LiDAR device 1000. In addition, such information may be utilized by smartphones, cellular phones, PDAs, laptops, PCs, wearable devices, and other mobile or non-mobile computing devices.

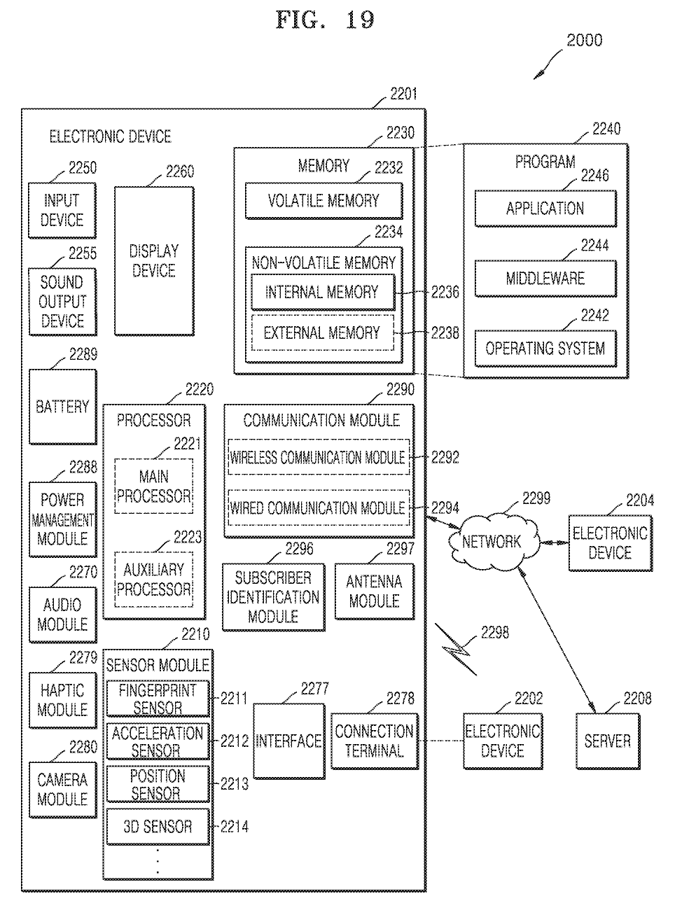

FIG. 19 is a block diagram showing a schematic configuration of an electronic device including a LiDAR device according to one or more embodiments.

Referring to FIG. 19, in a network environment 2000, an electronic device 2201 may communicate with another electronic device 2202 through a first network 2298 (a short-range wireless communication network, etc.) or communicate with another electronic device 2204 and/or a server 2208 through a second network 2299 (a long-range wireless communication network, etc.). The electronic device 2201 may communicate with the electronic device 2204 via the server 2208. The electronic device 2201 may include a processor 2220, a memory 2230, an input device 2250, a sound output device 2255, a display device 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297. In the electronic device 2201, some (the display device 2260, etc.) of the components may be omitted or another component may be added. Some of the components may be configured as one integrated circuit. For example, a fingerprint sensor 2211, an iris sensor, an illumination sensor, etc., of the sensor module 2210 may be implemented as being embedded in the display device 2260 (a display, etc.).

The processor 2220 may control one or more components (hardware, software components, etc.) of the electronic device 2201 connected to the processor 2220 by executing software (the program 2240, etc.), and may perform various data processes or operations. As a part of the data processes or operations, the processor 2220 may load a command and/or data received from another component (the sensor module 2210, the communication module 2290, etc.) to a volatile memory 2232, may process the command and/or data stored in the volatile memory 2232, and may store result data in a non-volatile memory 2234. The processor 2220 may include a main processor 2221 (a central processing unit, an application processor, etc.) and an auxiliary processor 2223 (a graphics processor unit (GPU), an image signal processor, a sensor hub processor, a communication processor, etc.) that may operate independently of or along with the main processor 2221. The auxiliary processor 2223 may use less power than that of the main processor 2221, and may perform specified functions.

The auxiliary processor 2223, on behalf of the main processor 2221 while the main processor 2221 is in an inactive state (a sleep state), or along with the main processor 2221 while the main processor 2221 is in an active state (an application executed state), may control functions and/or states related to some (the display device 2260, the sensor module 2210, the communication module 2290, etc.) of the components of the electronic device 2201. The auxiliary processor 2223 (the image signal processor, the communication processor, etc.) may be implemented as a part of another component (the camera module 2280, the communication module 2290, etc.) that is functionally related thereto.

The memory 2230 may store various data required by the components (the processor 2220, the sensor module 2276, etc.) of the electronic device 2201. The data may include, for example, software (the program 2240, etc.) and input data and/or output data about commands related thereto. The memory 2230 may include the volatile memory 2232 or the non-volatile memory 2234.

The program 2240 may be stored as software in the memory 2230, and may include an operating system 2242, middleware 2244, and/or an application 2246.

The input device 2250 may receive commands and/or data to be used in the components (the processor 2220, etc.) of the electronic device 2201, from the outside (a user, etc.) of the electronic device 2201. The input device 2250 may include a microphone, a mouse, a keyboard, and/or a digital pen (a stylus pen).

The sound output device 2255 may output a sound signal to the outside of the electronic device 2201. The sound output device 2255 may include a speaker and/or a receiver. The speaker may be used for a general purpose such as multimedia reproduction or record play, and the receiver may be used to receive a call. The receiver may be coupled as a part of the speaker or may be implemented as an independent separate device.

The display device 2260 may provide visual information to the outside of the electronic device 2201. The display device 2260 may include a display, a hologram device, or a projector, and a control circuit for controlling the corresponding device. The display device 2260 may include a touch circuitry configured to sense a touch, and/or a sensor circuit (a pressure sensor, etc.) that is configured to measure a strength of a force generated by the touch.

The audio module 2270 may convert sound into an electrical signal or vice versa. The audio module 2270 may acquire sound through the input device 2250, or may output sound via the sound output device 2255 and/or a speaker and/or headphones of another electronic device (the electronic device 2202, etc.) connected directly or wirelessly to the electronic device 2201.

The sensor module 2210 may sense an operating state (power, temperature, etc.) of the electronic device 2201, or an outer environmental state (a user state, etc.), and may generate an electrical signal and/or a data value corresponding to the sensed state. The sensor module 2210 may include the fingerprint sensor 2211, an acceleration sensor 2212, a position sensor 2213, a three-dimensional (3D) sensor 2214, etc., and may also include an iris sensor, a gyro sensor, a pressure sensor, a magnetic sensor, a grip sensor, a proximity sensor, a color sensor, an infrared (IR) sensor, a biometric sensor, a temperature sensor, a humidity sensor, and/or an illumination sensor.

The 3D sensor 2214 may radiate selected light to the object and interpret the light reflected from the object to sense the shape, motion, etc., of the object, and the LiDAR device 1000 including the FPA system 100 described with reference to FIGS. 1 to 16 may be employed as the 3D sensor 2214.

The interface 2277 may support one or more designated protocols that may be used in order for the electronic device 2201 to be directly or wirelessly connected to another electronic device (the electronic device 2202, etc.). The interface 2277 may include a high-definition multimedia interface (HDMI), a universal serial bus (USB) interface, a secure digital (SD) card interface, and/or an audio interface.

The connection terminal 2278 may include a connector by which the electronic device 2201 may be physically connected to another electronic device (the electronic device 2202, etc.). The connection terminal 2278 may include an HDMI connector, a USB connector, an SD card connector, and/or an audio connector (a headphones connector, etc.).

The haptic module 2279 may convert the electrical signal into a mechanical stimulation (vibration, motion, etc.) or an electric stimulation that the user may sense through a tactile or motion sensation. The haptic module 2279 may include a motor, a piezoelectric device, and/or an electric stimulus device.

The camera module 2280 may capture a still image and a moving image. The camera module 2280 may include a lens assembly including one or more lenses, image sensors, image signal processors, and/or flashes. The lens assembly included in the camera module 2280 may collect light emitted from an object that is an object to be captured.

The power management module 2288 may manage power supplied to the electronic device 2201. The power management module 2288 may be implemented as a part of a power management integrated circuit (PMIC).

The battery 2289 may supply electric power to components of the electronic device 2201. The battery 2289 may include a primary battery that is not rechargeable, a secondary battery that is rechargeable, and/or a fuel cell.

The communication module 2290 may support establishment of a direct (wired) communication channel and/or a wireless communication channel between the electronic device 2201 and another electronic device (the electronic device 2202, the electronic device 2204, the server 2208, etc.), and execution of communication through the established communication channel. The communication module 2290 may operate independently of the processor 2220 (the application processor, etc.), and may include one or more communication processors that support the direct communication and/or the wireless communication. The communication module 2290 may include a wireless communication module 2292 (a cellular communication module, a short-range wireless communication module, a global navigation satellite system (GNSS) communication module) and/or a wired communication module 2294 (a local area network (LAN) communication module, a power line communication module, etc.). From among the communication modules, a corresponding communication module may communicate with another electronic device via the first network 2298 (a short-range communication network such as Bluetooth, Wireless Fidelity (WiFi) Direct, or Infrared Data Association (IrDA)) or the second network 2299 (a long-range communication network such as a cellular network, the Internet, or a computer network (LAN, a wide area network (WAN), etc.)). Such various kinds of communication modules may be integrated as one component (a single chip, etc.) or may be implemented as a plurality of components (a plurality of chips) separately from one another. The wireless communication module 2292 may identify and authenticate the electronic device 2201 in a communication network such as the first network 2298 and/or the second network 2299 by using subscriber information (an international mobile subscriber identifier (IMSI), etc.) stored in the subscriber identification module 2296.

The antenna module 2297 may transmit or receive a signal and/or power to/from outside (another electronic device, etc.). An antenna may include a radiator formed as a conductive pattern formed on a substrate (a printed circuit board (PCB), etc.). The antenna module 2297 may include one or more antennas. When the antenna module 2297 includes a plurality of antennas, an antenna that is suitable for a communication scheme used in the communication network such as the first network 2298 and/or the second network 2299 may be selected by the communication module 2290 from among the plurality of antennas. The signal and/or the power may be transmitted between the communication module 2290 and another electronic device via the selected antenna. Another component (a radio frequency integrated circuit (RFIC), etc.) other than the antenna may be included as a part of the antenna module 2297.

Some of the components may be connected to one another via a communication scheme between peripheral devices (a bus, general purpose input and output (GPIO), a serial peripheral interface (SPI), a mobile industry processor interface (MIPI), etc.) and may exchange signals (commands, data, etc.).

The command or data may be transmitted or received between the electronic device 2201 and the external electronic device, that is, the electronic device 2204, via the server 2208 connected to the second network 2299. Other electronic devices, that is, the electronic devices 2202 and 2204, may be devices of types that are the same as or different from the electronic device 2201. All or some of operations executed in the electronic device 2201 may be executed in one or more devices among the other electronic devices (the electronic devices 2202 and 2204 and the server 2208). For example, when the electronic device 2201 has to perform a certain function or service, the electronic device 2201 may request one or more other electronic devices to perform some or all of the function or service, instead of executing the function or service itself. One or more electronic devices receiving the request execute an additional function or service related to the request and may transfer a result of the execution to the electronic device 2201. To this end, cloud computing, distributed computing, and/or a client-server computing may be used.

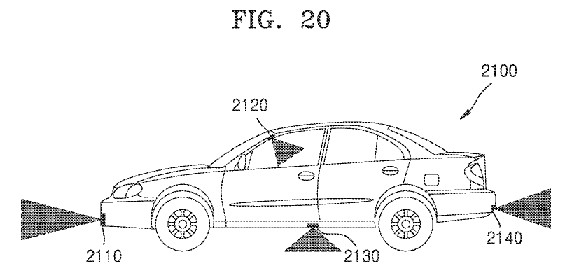

FIG. 20 schematically shows an example in which the LiDAR device according to one or more embodiments is applied to a vehicle 2100.

Referring to FIG. 20, the vehicle 2100 may include a plurality of LiDAR devices 2110, 2120, 2130, and 2140 arranged at various positions. The vehicle 2100 may provide the driver with various information about the periphery of the vehicle 2100 by using the plurality of LiDAR devices 2110, 2120, 2130, and 2140, and may provide the driver with information necessary for autonomous driving by automatically recognizing a nearby object or person. The plurality of LiDAR devices 2110, 2120, 2130, and 2140 may use, for example, a time-of-flight (TOF) scheme to obtain the information about the object. The vehicle 2100 may be a vehicle, for example, having an autonomous driving function. By using the plurality of LiDAR devices 2110, 2120, 2130, and 2140, an object, i.e., a thing or a person, in the traveling direction of the vehicle 2100 may be detected, and the distance to the object may be measured using information such as the time difference between a transmitted signal and a received signal, etc. Information about a close object and a distant object in a target area may also be obtained.

The plurality of LiDAR devices 2110, 2120, 2130, and 2140 may use the LiDAR device 1000 including the FPA system 100 described with reference to FIGS. 1 to 18.

While it is shown in FIG. 20 that the LiDAR device is applied to a vehicle as an example, the disclosure is not limited thereto. The LiDAR device may be applied to autonomous vehicles, flying objects such as drones, mobile devices, small walking devices (e.g., bicycles, motorcycles, baby strollers, skateboards, etc.), robots, human/animal assistance devices (e.g., canes, helmets, accessories, clothing, watches, bags, etc.), Internet of Things (IoT) devices/systems, security devices/systems, etc.

As described above, in the FPA system 100 according to one or more embodiments, an interference light beam Lo travels through the waveguide 210, etc., in a plane, thereby minimizing light loss occurring in a photonic integrated circuit (IC). This reduction in light loss may enhance a signal-to-noise ratio (SNR) of an interference signal, which is crucial for accurate distance measurement. Thus, the FPA system 100 according to one or more embodiments may implement an FMCW-based LiDAR device or a distance measurement system with high energy efficiency by minimizing the light loss occurring in the plane of the photonic IC. The FPA system 100 according to one or more embodiments may be applied to a LiDAR device in the form of a chip (LiDAR chip). The LiDAR chip may be integrated into a variety of products, such as autonomous vehicles, robotic systems, and other applications requiring precise distance measurement. An optical IC chip-based optical interferometer structure used in the FPA system 100 may be used in various optical sensor systems.

While the FPA system 100, the LiDAR device including the same, and a device including the LiDAR device have been described with reference to the embodiments shown in the drawings, it will be understood by those of ordinary skill in the art that they are merely examples and various modifications and variations may be made.

The FPA system and the LiDAR device including the same according to one or more embodiments may include an output coupler having an inclined cross-section (e.g., an inclined edge or an inclined side surface) in a light-output area and a nano-structure element positioned at a different level from the output coupler. This configuration allows the radiation of light to several positions according to the wavelength of incident light within a single light-output area, resulting in high light-output efficiency, and an increased number of measurement points.

The FPA system and the LiDAR device including the same according to one or more embodiments may include the output coupler having the inclined cross-section in the light-output area and the nano-structure element, thereby increasing the resolution of the LiDAR device.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An optical sensor comprising:
an input coupler configured to couple a light beam;
a plurality of pixels on a substrate; and
a waveguide configured to transmit the light beam to the plurality of pixels,
wherein each of the plurality of pixels comprises:
an optical switch configured to selectively transmit the light beam;
an output coupler comprising an inclined side surface and configured to change a traveling direction of the light beam to output the light beam in the changed traveling direction; and
a nano-structure element on a traveling path of the light beam output from the output coupler and comprising at least one nano structure.

2. The optical sensor of claim 1, wherein the input coupler, the plurality of pixels, and the waveguide are arranged as part of a focal plane array, and
wherein the output coupler and the waveguide are at a same level relative to the substrate.

3. The optical sensor of claim 1, wherein the output coupler and the waveguide are at different levels relative to the substrate.

4. The optical sensor of claim 1, wherein the output coupler comprises silicon nitride (Si₃N₄), amorphous silicon (a-Si), or a combination thereof.

5. The optical sensor of claim 1, wherein the at least one nano structure has a size less than a wavelength of an incident light.

6. The optical sensor of claim 1, wherein the at least one nano structure comprises a lattice structure having a pitch that ranges from 50 nm to 500 nm.

7. The optical sensor of claim 1, wherein the at least one nano structure comprises a lattice structure having a depth that ranges from 100 nm to 350 nm.

8. The optical sensor of claim 1, wherein the at least one nano structure comprises a lattice structure having a duty ratio that ranges from 10 % to 50 %.

9. The optical sensor of claim 1, wherein the at least one nano structure has a shape of a cylinder or a polyprism.

10. The optical sensor of claim 9, wherein a width of the cylinder or the polyprism ranges from 50 nm to 500 nm.

11. The optical sensor of claim 1, wherein the optical switch is configured to be driven by heat or electric current.

12. The optical sensor of claim 1, further comprising a heater provided on the optical switch, the heater comprising tungsten (W), titanium nitride (TiN), gold (Au), silicon (Si), or a combination thereof.

13. A light detection and ranging (LiDAR) device comprising:
a processor configured to control the LiDAR device;
an input coupler configured to couple a light beam incident on the LiDAR device;
a plurality of pixels configured to receive the light beam reflected from an object;
a waveguide configured to transmit the light beam from the input coupler to the plurality of pixels,
wherein each of the plurality of pixels is provided on a substrate and comprises:
an optical switch configured to selectively transmit the light beam;
an output coupler comprising an inclined side surface and configured to change a traveling direction of the light beam to output the light beam in the changed traveling direction; and
a nano-structure element provided on a traveling path of the light beam output from the output coupler and comprising at least one nano structure.

14. The LiDAR device of claim 13, wherein the output coupler and the waveguide are at different levels relative to the substrate.

15. The LiDAR device of claim 13, wherein the output coupler and the waveguide are at different levels relative to the substrate.

16. The LiDAR device of claim 13, wherein the at least one nano structure has a size less than a wavelength of an incident light.

17. The LiDAR device of claim 13, wherein the at least one nano structure comprises a lattice structure having a pitch that ranges from 50 nm to 500 nm and a depth that ranges from 100 nm to 350 nm.

18. The LiDAR device of claim 13, wherein the at least one nano structure comprises a lattice structure having a duty ratio that ranges from 10 % to 50 %.

19. An optical sensor comprising:
a plurality of pixels on a substrate, each of the plurality of pixels comprising:
an input coupler configured to couple incident light;
an output coupler comprising an inclined side surface;
a waveguide extending from the input coupler to the output coupler; and
a nanostructure positioned at a level different from a level of the output coupler relative to the substrate;
wherein the inclined side surface of the output coupler is configured to redirect the light toward the nanostructure at the different level.

20. The optical sensor of claim 19, wherein the nanostructure comprises a grating structure or a nano-rod structure, each of the grating structure and the nano-rod structure has a pitch less than a wavelength of the incident light.
